(19) United States
(12) Patent Application Publication
(10) Pub. No.: US 2010/0321166 A1
(43) Pub. Date: Dec. 23, 2010

(54) Radio Frequency Identification Reader/Writer and a Method for Implementing Antenna Switching

(76) Inventors: Dieter Horst, Cadolzburg (DE); Mattias Lampe, Beijing (CN); Hui Li, Beijing (CN); Dan Yu, Beijing (CN); Yong Yuan, Beijing (CN); Liang Zhang, Beijing (CN)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/528,115

(22) PCT Filed: Aug. 1, 2008
(86) PCT No.: PCT/EP2008/060116

§ 371 Date: Aug. 21, 2009

(30) Foreign Application Priority Data
Oct. 9, 2007 (EP) 200710162984.3

(51) Int. Cl. H04Q 5/22

(52) U.S. Cl. 340/10.51

(57) ABSTRACT

An RFID reader/writer including a reader/writer body, antennas and an antenna switching unit is provided. The reader/writer body distributes to each of its own ports a length of sustained time for transmitting a signal. One end of the antenna switching unit is connected to one port of the reader/writer body, while the other end is connected to two antennas. The antenna switching unit acquires a length of sustained time for the signal transmission distributed to the port by the reader/writer body, configures the time-length for the signal transmission and the sequence thereof of the two antennas according to the length of sustained time for the signal transmission, obtains a configuration result for signal transmission, and performs a switching control on the signal transmission of the two antennas according to the signal transmission configuration result. Further, an implementation method for the antenna switching of the RFID reader/writer is described.

### CROSS REFERENCE TO RELATED APPLICATIONS

This application is the US National Stage of International Application No. PCT/EP2008/060116 filed Aug. 1, 2008 and claims the benefit thereof. The International Application claims the benefits of Chinese Application No. 200710162984.3 CN filed Oct. 9, 2007; both of the applications are incorporated by reference herein in their entirety.

### FIELD OF INVENTION

The present invention relates to radio frequency identification (RFID) technology, in particular to an RFID reader/writer and a method for implementing antenna switching.

### BACKGROUND OF INVENTION

RFID is an automatic identification technology which comprises: bar code recognition, optical character recognition, smart card recognition, biometric identification and so on. In an RFID system, it mainly comprises an RFID tag and an RFID reader/writer.

FIG. 1 is a structural diagram of an RFID reader/writer according to the prior art. As shown in FIG. 1, the RFID reader/writer comprises: a reader/writer body 100 and antennas 200, wherein, each of the antennas 200 corresponds to a port of the reader/writer body 100; the reader/writer body 100 controls the signal transmitting and receiving by antennas 200 at each port according to preset rules, and only one antenna 200 transmits a signal at any one time, while the other antennas 200 receive a signal. When it is in practical implementation, the reader/writer body 100 distributes to each port a certain length of sustained time for the signal transmission according to the preset rules, and the antenna 200 connected to each port performs the signal transmission within the length of sustained time for the signal transmission. The RFID tags are used to identify the information of an object to be identified, and when an RFID tag carrier is moved into the coverage area in which the antenna 200 of the RFID reader/writer performs the signal transmission, the RFID tag is activated; the information in the RFID tag is received via the antenna 200 used for signal receiving by the RFID reader/writer, and the reader/writer body 100 in the RFID reader/writer identifies and processes the received information.

Currently, RFID technology has gained ever increasing attention, and is widely used in the fields of animal tracking, marine container tracking, tracking applications in the military and aviation fields, and so on, and furthermore, it is also used in supply chain management, and daily applications for consumers such as vehicle recognition at toll stations and refilling stations, and so on. When the tracking is carried out, the RFID reader/writer can determine the position of an RFID tag according to the coverage area of the antennas corresponding to the activated RFID tag.

In order to meet the increasing application demands, an RFID system should be able to ensure compliance with performance requirements in different reading ranges. However, in many cases, due to the transmitting power limitation of antennas 200 of the RFID reader/writer and the limitation in the number of antennas 200 supported in the RFID system in the prior art, the coverage area of the RFID reader/writer cannot satisfy the performance requirements of the RFID system.

In order to expand the coverage area by an RFID reader/writer, there exists a solution in the prior art, which is: a power divider is set in each port of a reader/writer body 100 of an RFID reader/writer, which is used to divide the signal power of each port so as to support more antennas 200; however in this technology the power is distributed to each of the antennas 200 after having been divided by the power divider, so it reduces the transmitting power of each of the antennas 200, therefore it does not expand the coverage area; and when an RFID tag is activated, there is also no way to determine into the coverage area of which antenna corresponding to the port the RFID tag has entered, so it cannot meet the requirements for high precision tracking.

### SUMMARY OF INVENTION

The present invention on the one hand provides an RFID reader/writer, and on the other hand provides a method for implementing antenna switching of the RFID reader/writer, so as to expand the coverage area of the RFID reader/writer.

The RFID reader/writer provided in the present invention comprises:

A reader/writer body and antennas, and said reader/writer body is used for distributing to each of its own ports a length of sustained time for transmitting a signal; and the RFID reader/writer also comprises: at least one antenna switching unit; one end of each of the antenna switching units is connected to one port of the reader/writer body, and the other end is connected to at least two antennas; said antenna switching unit is used to acquire the length of sustained time for the signal transmission distributed to said port by said reader/writer body, to perform a configuration of the time-length for the signal transmission and sequence thereof of said at least two antennas according to said length of sustained time for the signal transmission, to obtain a configuration result for the signal transmission, and to perform a switching control on the signal transmission of said at least two antennas according to said configuration result of the signal transmission.

Wherein, said antenna switching unit comprises:

A transmission time-length control module for acquiring the length of sustained time for the signal transmission distributed to said port by said reader/writer body; configuring, according to said length of sustained time for the signal transmission, the time-length for the signal transmission and sequence thereof of said at least two antennas in accordance with a preset configuration strategy; transmitting, according to said configuration result, a control signal to a switching module during the signal transmission;
a switching module for performing a switching operation on the signal transmission by said at least two antennas according to the control signal from said transmission time-length control module.

Wherein, said transmission time-length control module comprises:

A signal transmission time-length acquisition module for acquiring the length of sustained time for the signal transmission distributed to said port by said reader/writer body;
an antenna transmission time-length configuration module for performing, according to the length of sustained time for the signal transmission acquired by said acquisition module, the configuration of the time-length for the signal transmission and sequence thereof of said at least two antennas in accordance with the preset configuration strategy; and
a control module for transmitting a control signal to the switching module during the signal transmission according to the signal transmission configuration result of said antenna transmission time-length configuration module.

Wherein, said signal transmission time-length acquisition module comprises:

A signal transmission start/stop time measurement module for measuring the power level of the signal passing through said port, for comparing the measurement result with a preset transmission power level threshold, and for determining the signal transmission's start time and stop time; and
a signal transmission time-length measurement module for recording the sustained time from the start time to the stop time of said signal transmission, so as to acquire the length of sustained time for the signal transmission distributed to said port by the reader/writer body.

Wherein, said antenna transmission time-length configuration module comprises:

A configuration strategy setting module for setting the signal transmission configuration strategy of said at least two antennas;
a transmission time-length distribution module for configuring the time-length for the signal transmission and sequence thereof of said at least two antennas in accordance with said signal transmission configuration strategy set in said configuration strategy setting module according to the length of sustained time for the signal transmission acquired by said signal transmission time-length acquisition module.

Wherein, said switching module comprises:

a first transmitting/receiving switching module, a second transmitting/receiving switching module, an antenna switching module and a coupler, wherein,
said first transmitting/receiving switching module comprises: a first transmitting/receiving interface, a first transmitting interface and a first receiving interface; said first transmitting/receiving interface is connected to a port of said reader/writer body, and a transmitting channel is formed between said first transmitting/receiving interface and said first transmitting interface, and a receiving channel is formed between said first transmitting/receiving interface and said first receiving interface; and each first transmitting/receiving switching module is used for switching said transmitting channel and receiving channel according to the control signal from said transmission time-length control module;
the number of said second transmitting/receiving switching modules is the same as the number of antennas, and each second transmitting/receiving switching module comprises: a second transmitting/receiving interface, a second transmitting interface and a second receiving interface; said second transmitting/receiving interface is connected to the antennas, and a transmitting channel is formed between said second transmitting/receiving interface and said second transmitting interface, and a receiving channel is formed between said second transmitting/receiving interface and said second receiving interface; and each second transmitting/receiving switching module is used for switching said transmitting channel and receiving channel according to the control signal from said transmission time-length control module;
said antenna switching module comprises: a signal receiving interface and signal transmitting interfaces of the same number as the number of antennas; said signal receiving interface is connected to the first transmitting interface of said first transmitting/receiving switching module, and each of said transmitting interfaces is connected to the second receiving interface of one of the second transmitting/receiving switching modules; and said antenna switching module is used for switching the channels between said signal receiving interface and each of the transmitting interfaces according to the control signal from said transmission time-length control module; and said coupler comprises: a signal transmitting interface and signal receiving interface of the same number as the number of antennas; said signal transmitting interface is connected to the first receiving interface of said first transmitting/receiving switching module, and each of said receiving interfaces is connected to the second transmitting interface of one of the second transmitting/receiving switching modules; and said coupler is used for coupling the signal from each second transmitting/receiving switching module, so as to output the signal obtained from one channel to the first transmitting/receiving switching module.

In the above RFID reader/writer, said reader/writer body further determines the antenna corresponding to an activated RFID tag according to said configuration result for the signal transmission, and determines the position of said RFID tag according to the coverage area of said antenna.

Wherein, said reader/writer body comprises:

An antenna transmission time-length determining module for determining the time-length for the signal transmission and sequence thereof of said at least two antennas corresponding to each port in accordance with the preset configuration strategy according to the length of sustained time for the signal transmission distributed to each port by the reader/writer body, so as to acquire the configuration result for signal transmission of said at least two antennas; and
an RFID tag position determining module for determining the antenna corresponding to the activated RFID tag according to said configuration result for signal transmission, and for determining the position of said RFID tag according to the coverage area of said antenna.

An implementation method for antenna switching of the RFID reader/writer provided by the present invention comprises:

At least one antenna switching unit disposed between a reader/writer body and the antennas, one end of each of the antenna switching units being connected to one port of the reader/writer body, and the other end being connected to at least two antennas; and the method comprises:
Acquiring with each of the antenna switching units the length of sustained time for the signal transmission distributed to the port connected to said antenna switching unit by the reader/writer body;
performing a configuration of the time-length for the signal transmission and sequence thereof of each of the antennas connected to said antenna switching unit according to said length of sustained time for the signal transmission, so as to acquire the configuration result for the signal transmission; and
performing a switching control on the signal transmission by each of the antennas connected to said antenna switching unit according to said configuration result for the signal transmission.

In this case, said step for acquiring with the antenna switching unit the length of sustained time for the signal transmission distributed to the port connected to said antenna switching unit by the reader/writer body comprises:

Measuring by said antenna switching unit the signal's power level passing through said port, comparing the obtained measurement result with a preset transmission power level threshold so as to determine the start time and the stop time of the signal transmission; and
recording the sustained time from the start time to the stop time of said signal transmission, so as to acquire the length of sustained time for the signal transmission distributed to said port by the reader/writer body.

In this case, said step for performing the configuration of the time-length for the signal transmission and sequence thereof of each of the antennas connected to said antenna switching unit according to said length of sustained time for the signal transmission so as to acquire the configuration result for the signal transmission comprises:

Setting a signal transmission configuration strategy for each of the antennas connected to said antenna switching unit; and
configuring the time-length for the signal transmission and sequence thereof of each said antenna in accordance with said signal transmission configuration strategy and according to said length of sustained time for the signal transmission, so as to acquire the signal transmission configuration result.

In this case, said signal transmission configuration strategy is the following:

said length of sustained time for the signal transmission is equally distributed to each of the antennas connected to said antenna switching unit, or, the length of sustained time for the signal transmission is distributed to each of the antennas connected to said antenna switching unit in accordance with a preset weighting coefficient; and
said step for performing the switching control on the signal transmission by said at least two antennas connected to said antenna switching unit according to the configuration result for the signal transmission is the following: according to the signal transmission configuration result, and during the signal transmission period, each of the antennas is controlled to perform the signal transmission in accordance with the time-length for the signal transmission and sequence thereof configured for said antenna.

In this case, said signal transmission configuration strategy is the following:

said length of sustained time for the signal transmission is distributed in turn to one of the antennas connected to said antenna switching unit; and
said step for performing the switching control on the signal transmission by said at least two antennas connected to said antenna switching unit according to the configuration result for the signal transmission is the following: according to the signal transmission configuration result, and during each signal transmission period, one antenna is separately controlled to perform the signal transmission in accordance with a polling sequence according to said length of sustained time for the signal transmission.

Preferably, the method further comprises the following: the reader/writer body sends a resetting signal to the antenna switching unit periodically, the antenna switching unit receives said resetting signal and begins with the initial antenna in the polling sequence to execute, in each transmission period, said step of one antenna being separately controlled to perform the signal transmission in accordance with the polling sequence according to said length of sustained time for the signal transmission.

Preferably, the method further comprises the following: the reader/writer body determines the antenna corresponding to the activated RFID tag according to said signal transmission configuration result, and determines the position of said RFID tag according to the coverage area of said antenna.

In this case, before the reader/writer body determines the antenna corresponding to the activated RFID tag according to said signal transmission configuration result, said method further comprises the following:

The reader/writer body determines the time-length for the signal transmission and sequence thereof of each of the antennas corresponding to the port in accordance with the preset configuration strategy according to the length of sustained time for the signal transmission distributed to each port by the reader/writer body, so as to acquire the signal transmission configuration result of each of the antennas.

It can be seen from the above technical solution that, in the present invention by setting at least one antenna switching unit between the reader/writer body and the antennas, with one end of each of the antenna switching units being connected to one port of the reader/writer body, while the other end thereof is connected to at least two antennas, it increases the number of antennas corresponding to a port, so under working conditions, each of the antenna switching units acquires the length of sustained time for the signal transmission distributed to the port connected to the antenna switching unit by the reader/writer body; the time-length for the signal transmission and sequence thereof of each of the antennas connected thereto are configured according to the length of sustained time for the signal transmission, and a switching control is performed on the signal transmission of each of the antennas connected to the antenna switching unit according to the acquired configuration result for the signal transmission; therefore there is no need to change the transmitting power distributed to each of the antennas, and the coverage area of the RFID reader/writer is expanded.

In addition, further, when performing the tracking, the reader/writer body determines the antenna corresponding to the activated RFID tag according the determined signal transmission configuration result, and determines the position of said RFID tag according to the coverage area of said antenna, so as to meet the requirements of tracking accuracy.

### BRIEF DESCRIPTION OF THE DRAWINGS

The abovementioned and other features and advantages of the present invention will become more apparent to those skilled in the art by the detailed description of the exemplary embodiments of the present invention below with reference to the drawings, in which:

FIG. 1 is a structural diagram of an RFID reader/writer according to the prior art;

FIG. 2 is a structural diagram of an RFID reader/writer in an embodiment of the present invention;

FIG. 3 is a structural and connection relationship diagram of an antenna switching unit in the RFID reader/writer shown in FIG. 2;

FIG. 4 is a structural and connection relationship diagram of a transmission time-length control module in the antenna switching unit shown in FIG. 3;

FIG. 5 is a structural diagram of a signal transmission time-length acquisition module in the transmission time-length control module shown in FIG. 4;

FIG. 6 is a structural diagram of an antenna transmission time-length configuration module in the transmission time-length control module shown in FIG. 4;

FIG. 7 is an internal structural diagram of the reader/writer body in the RFID reader/writer shown in FIG. 2;

FIG. 8 is a structural and connection relationship diagram of a switching module in the antenna switching unit shown in FIG. 3;

FIG. 9 is a schematic flowchart of a method for implementing the antenna switching of the RFID reader/writer in an embodiment of the present invention;

FIG. 10 is a structural diagram of the RFID reader/writer in embodiment one of the present invention;

FIG. 11 is a schematic diagram of the transmission time and sequence of the antennas of the RFID reader/writer in embodiment one of the present invention; and

FIG. 12 is a schematic diagram of the transmission time and sequence of the antennas of the RFID reader/writer in embodiment two of the present invention.

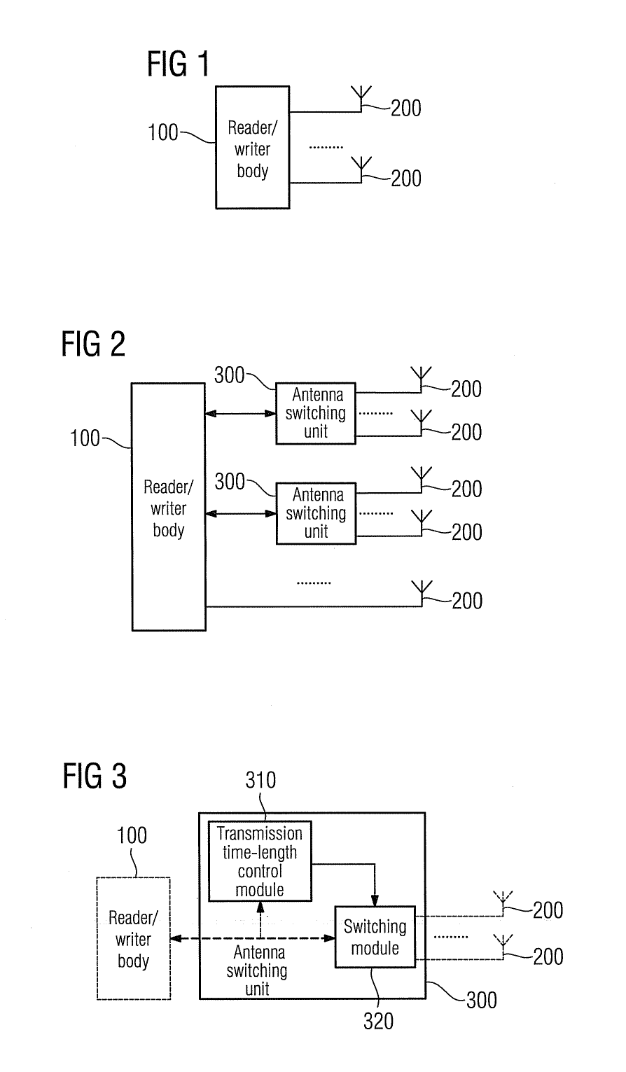

### DETAILED DESCRIPTION OF INVENTION

In order to make the objects, technical solutions and advantages of the present invention more apparent, the present invention will be further described below by referring to the drawings and by way of embodiments.

FIG. 2 is a structural diagram of an RFID reader/writer in an embodiment of the present invention. As shown in FIG. 2, the RFID reader/writer comprises: a reader/writer body 100, antennas 200 and at least one antenna switching unit 300, in which, one end of each of the antenna switching units 300 is connected to a port of the reader/writer body 100, and the other end is connected to at least two antennas 200. By adding the antenna switching unit 300, and thus increasing the number of antennas 200 corresponding to a port, when in practical operation, there is no need to change the transmitting power of each of the antennas 200; only the switching of the signal transmission of each of the antennas 200 corresponding to the port is performed by the antenna switching unit 300, thus expanding the number of antennas 200 supported by the RFID reader/writer, and the number of antenna switching units 300 can be configured according to practical needs.

When in practical operation, the antenna switching unit 300 acquires the length of sustained time for the signal transmission distributed to the port connected to the antenna switching unit 300 by the reader/writer body 100, configures the time-length for the signal transmission (namely, the time-length for performing the signal transmission by each of the antennas 200) and sequence of each of the antennas 200 connected to the antenna switching unit 300 according to the length of sustained time for the signal transmission, so as to acquire the configuration result for the signal transmission (including the time-length for the signal transmission and sequence of each of the antennas 200), and performs a switching control on the signal transmission of each of the antennas 200 connected to the antenna switching unit 300 according to the configuration result for the signal transmission.

The reader/writer body 100 determines the antenna 200 corresponding to the activated RFID tag according to the configuration result for the signal transmission, and determines the position of the RFID tag according to the coverage area of the determined antenna 200.

When in practical application, there can be a plurality of forms for realizing the internal structure of each of the antenna switching units 300, and FIG. 3 is a structural and connection relationship diagram of the antenna switching unit 300. As shown in FIG. 3, the antenna switching unit 300 can comprise: a transmission time-length control module 310 and a switching module 320. In FIG. 3, for the sake of clarity, the thick lines are used to represent the signal transmission lines, the thin lines to represent the test and control lines, the solid lines to represent the antenna switching unit 300 and the internal structure thereof, the dashed lines to represent the outside components connected to the antenna switching unit 300.

In this case, the transmission time-length control module 310 is used for acquiring the length of sustained time for the signal transmission distributed to the port connected to the antenna switching unit 300 by said reader/writer body 100; for configuring, according to said length of sustained time for the signal transmission, the time-length for the signal transmission and sequence of each of the antennas 200 connected to the antenna switching unit 300 in accordance with the preset configuration strategy; and for transmitting, according to said configuration result and during the signal transmission, a control signal to the switching module 320.

The switching module 320 is used for switching the signal transmission by each of the antennas 200 connected to the antenna switching unit 300 according to the control signal from the transmission time-length control module 310, namely to switch the transmitted signal received by the input port of the switching module 320 from one output port to another output port, and correspondingly, it realizes the switching of the signal transmission from one antenna 200 to another antenna 200.

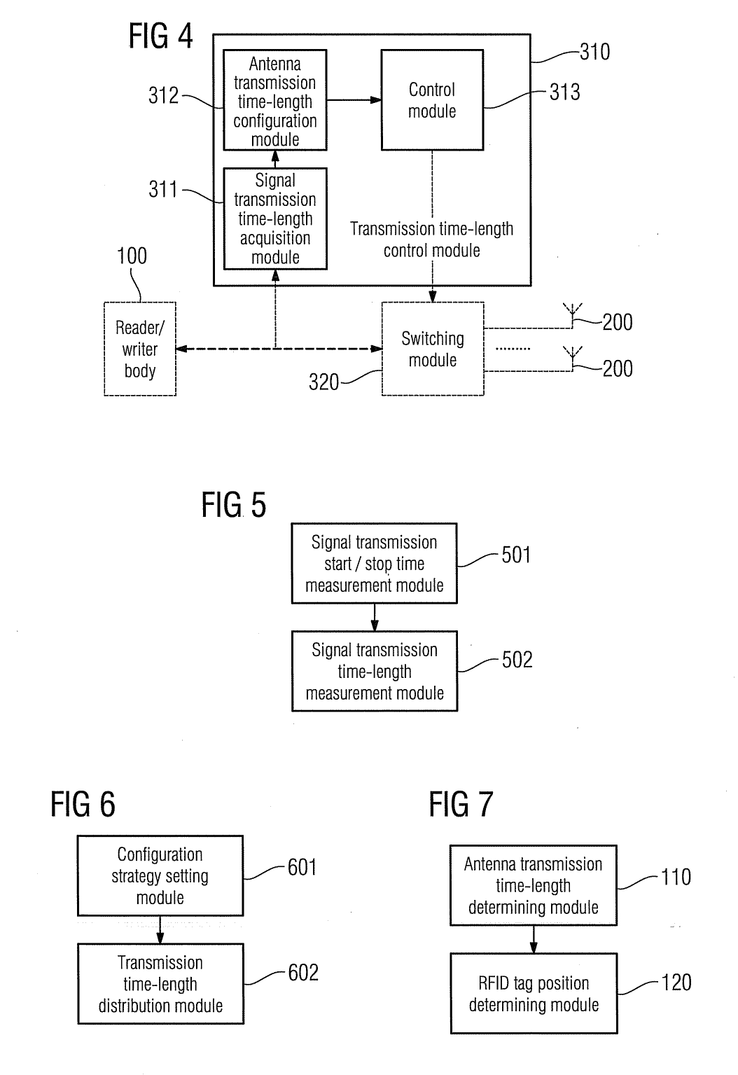

In this case, when it is in a practical implementation of the transmission time-length control module 310, it can be composed of different logic function modules, as shown in FIG. 4, and FIG. 4 shows a structural and connection relationship diagram of the transmission time-length control module 310. As shown in FIG. 4, the transmission time-length control module 310 comprises three logic function modules: a signal transmission time-length acquisition module 311, an antenna transmission time-length configuration module 312, and a control module 313. In FIG. 4, for the sake of clarity, the thick lines are used to represent the signal transmission lines, the thin lines to represent the test and control lines, the solid lines to represent the transmission time-length control module 310 and the internal structure thereof, and the dash lines to represent the components connected to but outside the transmission time-length control module 310.

In this case, the signal transmission time-length acquisition module 311 is used for acquiring the length of sustained time for the signal transmission distributed by said reader/writer body 100 to the port connected to the antenna switching unit 300.

The antenna transmission time-length configuration module 312 is used for performing the configuration of the time-length for the signal transmission and sequence of each of the antennas 200 connected to the antenna switching unit 300 in accordance with a preset configuration strategy and according to the length of sustained time for the signal transmission acquired by the signal transmission time-length acquisition module 311.

The control module 313 is used for transmitting a control signal to the switching module 320 during the signal transmission according to the signal transmission configuration result from the antenna transmission time-length configuration module 312.

When it is in a practical implementation, there are a plurality of realization methods for the antenna switching unit 300 to acquire the length of sustained time for the signal transmission distributed by the reader/writer body 100 to the port connected to the antenna switching unit 300, for example it can be as follows: the antenna switching unit 300 performs a measurement on the power level of the signal passing through the port connected thereto, compares the measurement result obtained with a preset transmission power level threshold, and determines the start time and stop time of the signal transmission, records the sustained time from the start time to the stop time for the signal transmission, so as to acquire the length of sustained time for the signal transmission distributed to the port by the reader/writer body 100.

Correspondingly, when it is in a practical implementation, inside the signal transmission time-length acquisition module 311, as shown in FIG. 5, there may be two logic function modules: a signal transmission start/stop time measurement module 501 and a signal transmission time-length measurement module 502; and FIG. 5 shows a structural diagram of a signal transmission time-length acquisition module 311 in the antenna switching unit 300.

In this case, the signal transmission start/stop time measurement module 501 is used for performing a measurement on the power level of the signal passing through the port connected to the antenna switching unit 300 to which it belongs, for comparing the measurement result obtained with a preset transmission power level threshold, and for determining the start time and stop time for the signal transmission. Wherein, the measurement of the signal power level can be by measuring the power level of the electric cable connecting the antenna switching unit 300 to the port.

The signal transmission time-length measurement module 502 is used for recording the sustained time from the start time to the stop time of said signal transmission, so as to acquire the length of sustained time for the signal transmission distributed to the port by the reader/writer body 100. When it is in a practical implementation, it can be recorded by an internal counter or timer.

When using this method, since at least one transmission cycle needs to be measured for the length of sustained time for the signal transmission, it is necessary to perform an initial transmission of the transmitted signal before acquiring the length of sustained time for the signal transmission and making a subsequent switching control, which can be done by using a current default antenna at this time, or it can also be done by setting other initial transmission strategies.

In addition, the method for the antenna switching unit 300 to acquire the length of sustained time for the signal transmission distributed by the reader/writer body 100 to the port connected to the antenna switching unit 300 can also be the following: the reader/writer body 100 informs the antenna switching unit 300 connected to the port of the length of sustained time for the signal transmission distributed by itself to the port.

In this case, an information transmission module can be set in the reader/writer body 100 for informing the antenna switching unit 300 connected to the port about the length of sustained time for the signal transmission distributed to the port by the reader/writer body 100.

Correspondingly, an information receiving module can be set within the antenna switching unit 300 for receiving the length of sustained time for the signal transmission distributed by the reader/writer body 100 to the port connected to the antenna switching unit 300.

In this case, the mode of transmitting and receiving can be via an I/O interface, or transmission can also be via an electric cable connecting the antenna switching unit 300 to the port.

When it is in a practical implementation, there are a plurality of methods for the antenna switching unit 300 to configure the time-length for the signal transmission and sequence of each of the antennas 200 connected to the antenna switching unit 300 in accordance with a preset configuration strategy and according to the length of sustained time for the signal transmission, for example it can be as follows: the configuration strategy for the signal transmission of each of the antennas 200 connected to the antenna switching unit 300 is set in advance in the antenna switching unit 300; and the antenna switching unit 300 configures the time-length for the signal transmission and sequence of each of the antennas 200 connected to the antenna switching unit 300 in accordance with the set configuration strategy for the signal transmission according to the length of sustained time for the signal transmission, so as to acquire the configuration result for the signal transmission.

Correspondingly, when it is in a practical implementation, inside the antenna transmission time-length configuration module 312 it can comprise two logic function modules as shown in FIG. 6: a configuration strategy setting module 601 and a transmitting time-length distribution module 602. FIG. 6 shows a structural diagram of the antenna transmission time-length configuration module 312 in the antenna switching unit 300.

In this case, the configuration strategy setting module 601 is used for setting the signal transmission configuration strategy of each of the antennas 200 connected to the antenna switching unit 300.

The transmission time-length distribution module 602 is used for configuring the time-length for the signal transmission and sequence of each of the antennas 200 connected to the antenna switching unit 300 in accordance with the signal transmission configuration strategy set in the configuration strategy setting module 601 and according to the length of sustained time for the signal transmission, so as to acquire the configuration result for the signal transmission.

In this case, the configuration strategy for the signal transmission can have a number of forms, for example, it can be in the form of averaged distribution, namely distributing the length of sustained time for the signal transmission equally to each of the antennas 200 connected to the antenna switching unit 300; or it can also be in the form of weighted distribution, namely distributing the length of sustained time for the signal transmission to each of the antennas 200 connected to the antenna switching unit 300 in accordance with a preset weighting coefficient; it can further be in the form of a polling distribution, namely distributing the length of sustained time for the signal transmission in turn to one of the antennas 200 connected to the antenna switching unit 300, and so on.

In this case, when one of the configuration strategies for the signal transmission is set, and the configuration of the time-length for the signal transmission and sequence of each of the antennas 200 connected to the antenna switching unit 300 is completed, then the configuration is readily made according to this particular configuration strategy for the signal transmission.

When a number of the configuration strategies for the signal transmission are set, and the configuration of the time-length for the signal transmission and sequence of each of the antennas 200 connected to the antenna switching unit 300 is completed, one of them can be selected according to the factors such as application situations and so on, and the configuration is made according to the selected configuration strategy for the signal transmission.

In this case, the process for the reader/writer body 100 to determine the configuration result for the signal transmission can be as follows: a configuration strategy for the signal transmission for each of the antennas connected to the antenna switching unit 300 is set in the reader/writer body 100 in advance, and this configuration strategy for the signal transmission is the same as the configuration strategy for the signal transmission set in the antenna switching unit 300. The reader/writer body 100 determines the time-length for the signal transmission and sequence of each of the antennas 200 connected to the antenna switching unit 300 in accordance with the set configuration strategy for the signal transmission (this configuration strategy for the signal transmission is the same as the configuration strategy for the signal transmission on which the antenna switching unit 300 is based when it configures the time-length for the signal transmission and sequence of each of the antennas 200) and according to the length of sustained time for the signal transmission distributed to the port connected to the antenna switching unit 300 by the body itself, so as to acquire the configuration result for the signal transmission.

Correspondingly, when it is to realize an operation that the reader/writer body 100 determines the antenna 200 corresponding to an activated RFID tag according to the configuration result for the signal transmission, and determines the position of the RFID tag according to the coverage area of the antenna 200, a corresponding logic function module can be set in the reader/writer body 100, and FIG. 7 shows an internal structural diagram of the reader/writer body 100. As shown in FIG. 7, the set logic function module comprises: an antenna transmission time-length determining module 110 and an RFID tag position determining module 120.

In this case, the antenna transmission time-length determining module 110 is used for determining the time-length for the signal transmission and sequence of each of the antennas 200 corresponding to the port in accordance with the preset configuration strategy according to the length of sustained time for the signal transmission distributed to each port by the reader/writer body 100, and for acquiring the configuration result for the signal transmission of each of the antennas 200.

The RFID tag position determining module 120 is used for determining the antenna 200 corresponding to the activated RFID tag according to the configuration result for the signal transmission, and for determining the position of the RFID tag according to the coverage area of the antenna 200.

In addition, the process for the reader/writer body 100 to determine the configuration result for the signal transmission can also be as follows: the antenna switching unit 300 sends to the reader/writer body 100 the configuration strategy for the signal transmission based on which it configures the time-length for the signal transmission and sequence of each of the antennas 200, and the reader/writer body 100, according to the configuration strategy for the signal transmission and the length of sustained time for the signal transmission distributed to the port, determines the time-length for the signal transmission and sequence of each of the antennas 200 corresponding to the port, so as to acquire the configuration result for the signal transmission of each of the antennas 200; or the antenna switching unit 300 sends to the reader/writer 100 the configuration result after it has configured the time-length for the signal transmission and sequence of each of the antennas 200.

Correspondingly, when it is in a practical implementation, a corresponding logic function module can be set in the reader/writer body 100, for example a configuration information processing module, which is used for receiving the configuration strategy for the signal transmission coming from the antenna switching unit 300, for determining the time-length for the signal transmission and sequence of each of the antennas 200 corresponding to the port according to the configuration strategy for the signal transmission and the length of sustained time for the signal transmission distributed to the port, and acquiring the configuration result for the signal transmission of each of the antennas 200; or the configuration information processing module is for receiving the configuration result for the signal transmission of each of the antennas 200 coming from the antenna switching unit 300.

In this case, the mode of transmitting and receiving can be via an I/O interface, and transmission can also be via an electric cable connecting the antenna switching unit 300 with the port.

The method for the antenna switching unit 300 to configure the time-length for the signal transmission and sequence of each of the antennas 200 connected to the antenna switching unit 300 in accordance with the preset configuration strategy and according to the length of sustained time for the signal transmission can also be as follows: the configuration strategy for the signal transmission of each of the antennas 200 connected to the antenna switching unit 300 is set in the reader/writer body 100 in advance; the set configuration strategy for the signal transmission is sent to the antenna switching unit 300; and the antenna switching unit 300 configures the time-length for the signal transmission and sequence of each of the antennas 200 connected to the antenna switching unit 300 in accordance with the received configuration strategy of the signal transmission and according to the length of sustained time for the signal transmission, so as to acquire the configuration result for the signal transmission.

Correspondingly, the antenna transmission time-length configuration module 312 can comprise a configuration strategy acquisition module and a transmission time-length distribution module. Wherein, the configuration strategy acquisition module is used for receiving the configuration strategy for the signal transmission coming from the reader/writer body 100; the transmission time-length distribution module is used for configuring the time-length for the signal transmission and sequence of each of the antennas 200 connected to the antenna switching unit 300 in accordance with the configuration strategy for the signal transmission acquired by the configuration strategy acquisition module and according to the length of sustained time for the signal transmission, so as to acquire the configuration result for the signal transmission.

In this case, the mode of transmitting and receiving can be via an I/O interface, and transmission can also be via an electric cable connecting the antenna switching unit 300 with the port.

In this case, as to the reader/writer body 100 itself, it can determine the time-length for the signal transmission and sequence of each of the antennas 200 connected to the antenna switching unit 300 in accordance with the configuration strategy for the signal transmission set in itself according to the length of sustained time for the signal transmission distributed by itself to the port connected to the antenna switching unit 300, so as to acquire the configuration result for the signal transmission.

Correspondingly, in the same way a logic function module as shown in FIG. 7 can be set in the reader/writer body 100.

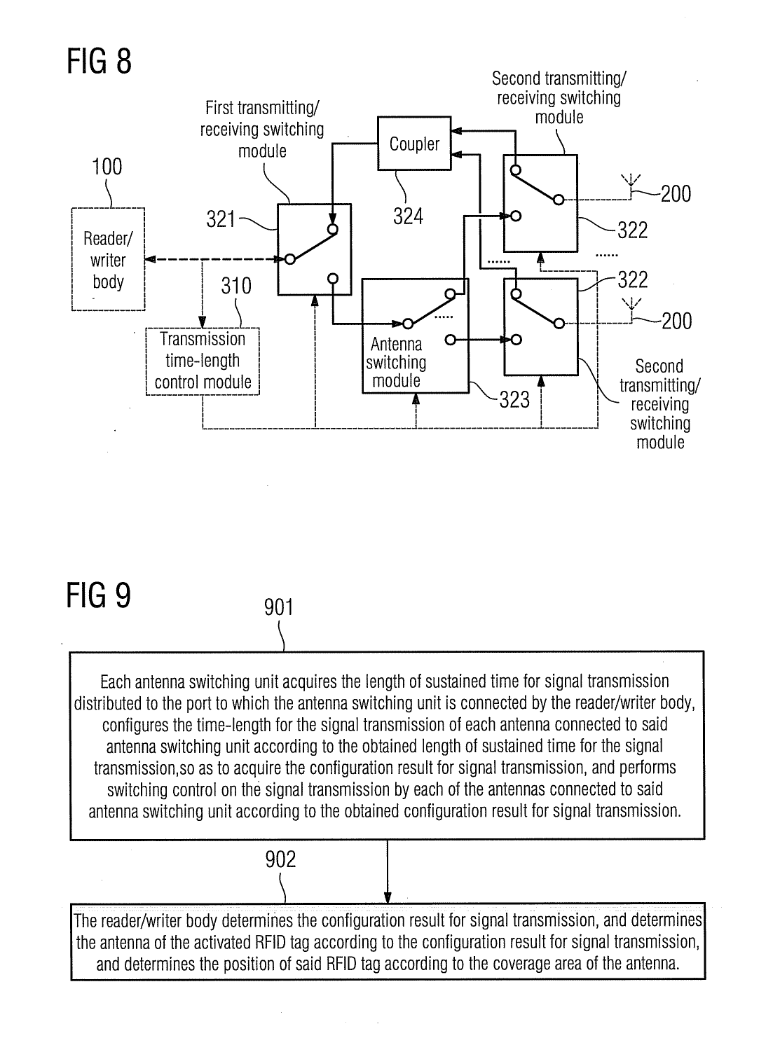

In addition, there are a number of ways for realizing the internal structure of the switching module 320 in the antenna switching unit 300, and FIG. 8 is a structural and connection relationship diagram of the switching module 320. As shown in FIG. 8, the switching module 320 can comprise: a first transmitting/receiving switching module 321 connected to one of the ports of the reader/writer body 100, a number of second transmitting/receiving switching modules 322 of the same number as the antennas 200, which are respectively connected to one of the antennas 200, an antenna switching module 323 which is positioned in a transmitting channel between the first transmitting/receiving switching module 321 and the second transmitting/receiving switching module 322, and a coupler 324 which is in the receiving channel between the first transmitting/receiving switching module 321 and the second transmitting/receiving switching module 322. In FIG. 8, for the sake of clarity, the thick lines are used to represent the signal transmitting lines, the thin lines to represent the test and control lines, the solid lines to represent the internal structure of the switching module 320, the dash lines to represent the components connected to but outside the switching module 320.

In this case, the first transmitting/receiving switching module 321 comprises: a first transmitting/receiving interface, a first transmitting interface and a first receiving interface; wherein, the first transmitting/receiving interface is connected to one of the ports of the reader/writer body 100, a transmitting channel is fanned between the first transmitting/receiving interface and the first transmitting interface, a receiving channel is formed between the first transmitting/receiving interface and the first receiving interface; and the first transmitting/receiving switching module 321 is used for switching the transmitting channel between the first transmitting/receiving interface and the first transmitting interface and the receiving channel between the first transmitting/receiving interface and the first receiving interface according to the control signal coming from said transmission time-length control module 310.

Each second transmitting/receiving switching module 322 comprises: a second transmitting/receiving interface, a second transmitting interface and a second receiving interface; said second transmitting/receiving interface is connected to an antenna, a transmitting channel is formed between the second transmitting/receiving interface and the second transmitting interface, a receiving channel is formed between the second transmitting/receiving interface and the second receiving interface; and the second transmitting/receiving switching module 322 is used for switching the transmitting channel between the second transmitting/receiving interface and the second transmitting interface and the receiving channel between the first transmitting/receiving interface and the second receiving interface according to the control signal coming from the transmission time-length control module 310.

The antenna switching module 323 comprises: a signal receiving interface and a number of signal transmitting interfaces of the same number as the antennas; said signal receiving interface is connected to the first transmitting interface of said first transmitting/receiving switching module 321, and each transmitting interface is connected to the second receiving interface of one of the second transmitting/receiving switching modules 322; the antenna switching module 323 is used for switching the channels between the signal receiving interface and each of the transmitting interfaces according to the control signal coming from said transmission time-length control module 310. Namely, the antenna switching module 323 switches the signal transmission of each of the antennas 200 connected to the antenna switching unit 300 according to the control signals coming from said transmission time-length control module 310.

The coupler 324 comprises: a signal transmitting interface and a number of signal receiving interfaces of the same number as the antennas; said signal transmitting interface is connected to the first receiving interface of the first transmitting/receiving switching module 321, and each of the receiving interfaces is connected to the second transmitting interface of one of the second transmitting/receiving switching modules 322; and the coupler 324 is used for coupling the signal from each second transmitting/receiving switching module 322, and outputting the obtained signal from one channel to the first transmitting/receiving switching module 321. Namely, the coupler 324 couples the signal coming from each of the antennas 200, and outputs the obtained signal from one channel to a port of the reader/writer body 100.

In addition, there are other forms for realizing the internal structure of the switching module 320, and it is usable as long as it can realize the switching at the time of signal transmission by each of the antennas 200, therefore no repeated description is needed here.

The detailed description given above is of the RFID reader/writer in the embodiments of the present invention, and an implementation method for antenna switching by the RFID reader/writer in the embodiments of the present invention is described in detail below.

FIG. 9 is an exemplary flowchart of an implementation method for the antenna switching by the RFID reader/writer in the embodiment of the present invention. In this method, at least one antenna switching unit is arranged between the reader/writer body and the antennas, and one end of each of the antenna switching units is connected to one of the ports of the reader/writer body, and the other end is connected to at least two antennas. As shown in FIG. 9, the flowchart comprises the following steps:

Step 901: each of the antenna switching units acquires the length of sustained time for the signal transmission distributed by the reader/writer body to the port connected to the antenna switching unit, configures the time-length for the signal transmission and sequence of each of the antennas connected to said antenna switching unit according to the obtained length of sustained time for the signal transmission, so as to acquire the signal transmission configuration result, and performs a switching control on the signal transmission of each of the antennas connected to said antenna switching unit according to the obtained configuration result for the signal transmission.

In this step, there are a number of methods for the antenna switching unit to acquire the length of sustained time for the signal transmission distributed by the reader/writer body to the port connected to the antenna switching unit, for example it can be as follows: the antenna switching unit measures the power level of the signal passing through the port connected to the antenna switching unit, compares the obtained measurement result with a preset transmission power level threshold, determines the start time and stop time for the signal transmission, and records the sustained time from the start time to the stop time for the signal transmission, so as to acquire the length of sustained time for the signal transmission distributed to the port by the reader/writer body.

When using this method, since at least one transmission cycle needs to be measured for the length of sustained time for the signal transmission, it is necessary to perform an initial transmission of the transmission signal before acquiring the length of sustained time for the signal transmission and performing the subsequent switching control, and at this moment it can be done by using the current default antenna, or it can also be done by setting other initial transmission strategies.

In addition, the method for the antenna switching unit to acquire the length of sustained time for the signal transmission distributed by the reader/writer body to the port connected to the antenna switching unit can also be as follows: The reader/writer body informs the antenna switching unit connected to the port of the length of sustained time for the signal transmission distributed to the port by itself. In this case, the mode of transmitting and receiving can be via the I/O interface, and transmission can also be via the electric cable connecting the antenna switching unit 300 with the port.

In this step, there are a number of methods for the antenna switching unit to configure the time-length for the signal transmission and sequence of each of the antennas connected to the antenna switching unit in accordance with preset configuration strategy and according to the length of sustained time for the signal transmission, and two of the implementation methods are given below.

The First Method:

The configuration strategy for the signal transmission of each of the antennas connected to the antenna switching unit is set in advance in the antenna switching unit; and the antenna switching unit configures the time-length for the signal transmission and sequence of each of the antennas connected to the antenna switching unit in accordance with the set configuration strategy for the signal transmission and according to the length of sustained time for the signal transmission, so as to acquire the configuration result for the signal transmission.

In this case, the configuration strategy for the signal transmission can be in a number of forms, for example it can be in the form of averaged distribution, namely distributing the length of sustained time for the signal transmission equally to each of the antennas connected to the antenna switching unit; it can also be in the form of weighted distribution, namely distributing the length of sustained time for the signal transmission to each of the antennas connected to the antenna switching unit in accordance with a preset weighting coefficient; it can further be in the form of polling distribution, namely distributing the length of sustained time for the signal transmission in turn to each of the antennas connected to the antenna switching unit, and so on.

When the configuration strategy for the signal transmission is in the form of averaged distribution or weighted distribution, during the signal transmission period, the antenna switching unit controls each of the antennas to perform the signal transmission in accordance with the time-length for the signal transmission and sequence of the configured antennas according to the configuration result for the signal transmission.

When the configuration strategy for the signal transmission is in the form of polling distribution, during each signal transmission period, the antenna switching unit separately controls one of the antennas, according to the polling sequence, to perform the signal transmission in accordance with said length of sustained time for the signal transmission according to the configuration result for the signal transmission. When it is in a practical implementation, it can be realized by counting the polling processes. For example, if one antenna switching unit has a total of n antennas, then it can be set that when the count value is 1, the antenna 1 carries out the signal transmission during this signal transmission period; when the count value is 2, the antenna 2 carries out the signal transmission during this signal transmission period, . . . ; when the count value is n, the antenna n carries out the signal transmission during this signal transmission period; and when the count value is n+1, the antenna 1 carries out the signal transmission during this signal transmission period, and so on. Further, in order to avoid counting errors caused by disassembling and assembling of the antenna switching unit or by counting faults, the reader/writer body can send a resetting signal to the antenna switching unit periodically, and when the antenna switching unit receives said resetting signal, it starts from the initial antenna (beginning with the count value 1) in the polling sequence, and during each signal transmission period, it controls one of the antennas separately to perform the signal transmission in accordance with the polling sequence and according to the length of sustained time for the signal transmission.

In this case, it can set just one configuration strategy for the signal transmission, then when performing the configuration of the time-length for the signal transmission and sequence of each of the antennas connected to the antenna switching unit, the configuration is readily made in accordance with this configuration strategy for signal transmission.

Alternatively, it can set a number of configuration strategies for the signal transmission, then when performing the configuration of the time-length for the signal transmission and sequence of each of the antennas connected to the antenna switching unit, it can be done by selecting one of them according to factors such as application situations and so on, and the configuration is carried out in accordance with the selected configuration strategy for the signal transmission.

The Second Method:

The configuration strategy for the signal transmission by each of the antennas connected to the antenna switching unit is set in advance in the reader/writer body, and the set configuration strategy for the signal transmission is sent to the antenna switching unit; then the antenna switching unit configures the time-length for the signal transmission and sequence of each of the antennas connected to the antenna switching unit in accordance with the received configuration strategy for the signal transmission and according to the length of sustained time for the signal transmission, so as to acquire the configuration result for the signal transmission.

Step 902: the reader/writer body determines the configuration result for signal transmission, determines the antenna corresponding to an activated RFID tag according to the configuration result for the signal transmission, and determines the position of said RFID tag according to the coverage area of the antenna.

In this step, there are a number of methods to determine the configuration result for the signal transmission, corresponding to the first method in step 901 for the antenna switching unit to configure the time-length for the signal transmission and sequence of each of the antennas connected thereto; it can be as follows: the configuration strategy for the signal transmission of each of the antennas connected to the antenna switching unit is set in advance in the reader/writer body, and this configuration strategy for the signal transmission is the same as the configuration strategy for the signal transmission set in the antenna switching unit. The reader/writer body determines the time-length for the signal transmission and sequence of each of the antennas connected to the antenna switching unit in accordance with the set configuration strategy for the signal transmission (this configuration strategy for the signal transmission is the same as the configuration strategy for the signal transmission based on which the antenna switching unit configures the time-length for the signal transmission and sequence of each of the antennas) and according to the length of sustained time for the signal transmission distributed by itself to the port connected to the antenna switching unit, so as to acquire the configuration result for the signal transmission.

In addition, when the method for determining the configuration result for the signal transmission corresponds to the first method in step 901 for the antenna switching unit to configure the time-length for the signal transmission and sequence of each of the antennas connected thereto, it can also be as follows: the antenna switching unit sends to the reader/writer body the configuration strategy for the signal transmission based on which it configures the time-length for the signal transmission and sequence of each of the antennas, and the reader/writer body determines the time-length for the signal transmission and sequence of each of the antennas corresponding to the port according to the configuration strategy for the signal transmission and the length of sustained time for the signal transmission distributed to each port, so as to acquire the configuration result for the signal transmission of each of the antennas; or the antenna switching unit sends to the reader/writer body the signal transmission configuration result obtained after it has configured the time-length for the signal transmission and sequence of each of the antennas.

Corresponding to the second method in step 901 for the antenna switching unit to configure the time-length for the signal transmission and sequence of each of the antennas connected thereto, the reader/writer body determines the time-length for the signal transmission and sequence of each of the antennas connected to the antenna switching unit in accordance with the configuration strategy for the signal transmission set in itself and according to the length of sustained time for the signal transmission distributed by itself to the port connected to the antenna switching unit, so as to acquire the configuration result for the signal transmission.

The RFID reader/writer and the implementation method thereof in the above embodiments are described below by two specific examples.

### Example One

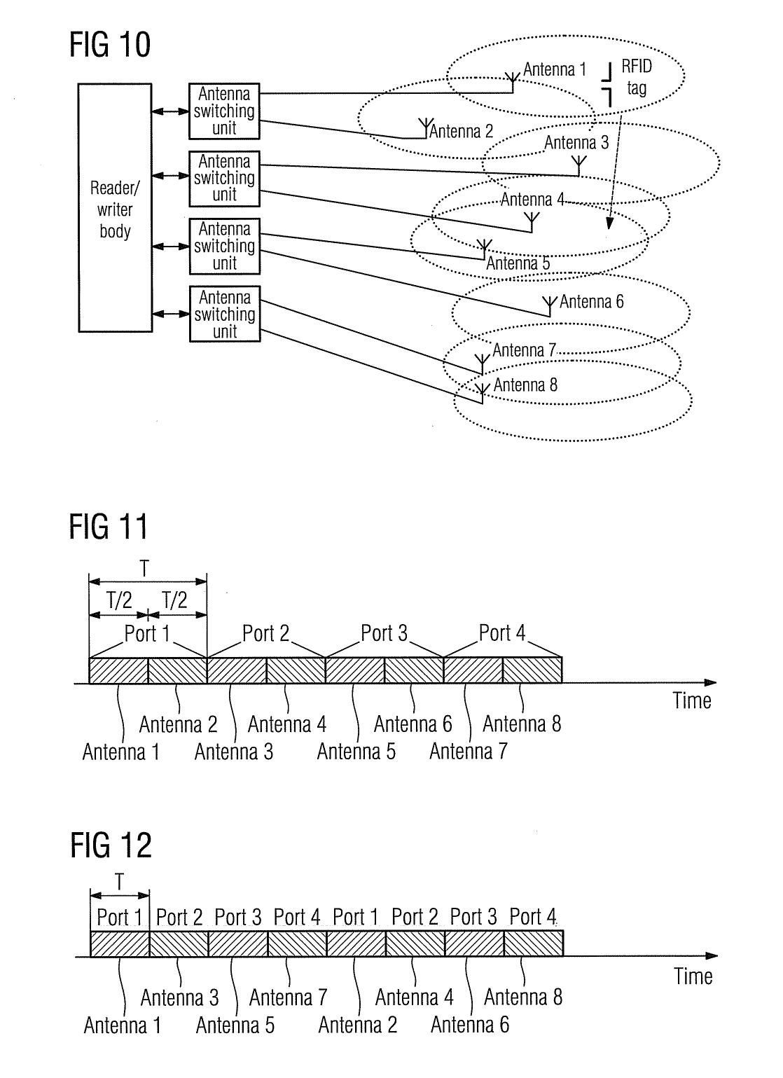

FIG. 10 is a structural diagram of the RFID reader/writer in example one of the present invention. As shown in FIG. 10, in this example, assume that the reader/writer body has four ports, from port 1 to port 4, and an antenna switching unit is fitted to each port, and each of the antenna switching units corresponds to two antennas; and assume that each of the antennas is separately labeled as antenna 1 to antenna 8 as shown in FIG. 10, then port 1 corresponds to antenna 1 and antenna 2, port 2 corresponds to antenna 3 and antenna 4, port 3 corresponds to antenna 5 and antenna 6, and port 4 corresponds to antenna 7 and antenna 8.

Further, assume that a configuration strategy for the signal transmission which is for equal distribution is set in advance in the reader/writer body and each of the antenna switching units, and assume the length of sustained time for the signal transmission distributed to each port by the reader/writer body is T.

When in practical operation, the antenna switching unit first measures the power level of the signal passing through the port of the reader/writer body connected to the antenna switching unit, and compares the measured result with a preset transmitting power level threshold; when it reaches the preset transmitting power level threshold, the initial time of reaching the signal transmission is determined, and the length of sustained time of the power level of reaching the preset transmitting power level threshold is recorded by the timer, so as to acquire the length of sustained time for the signal transmission distributed to the port by the reader/writer body.

The antenna switching unit, according to the obtained length of sustained time for the signal transmission, distributes separately a time-length of T/2 for the signal transmission to the two antennas connected to the antenna switching unit in accordance with the configuration strategy of the averaged distribution; for example, as for the two antennas corresponding to port 1, a time-length for signal transmission T1=T2=T/2 is distributed separately to the antenna 1 and antenna 2.

During the signal transmission, if the reader/writer body selects port 1 to port 4 in turn for the signal transmission, and the antenna switching unit corresponding to each port distributes to the two antennas a time-length of T/2 for the signal transmission in turn, then the transmission time and sequence of each of the antennas is as shown in FIG. 11.

Correspondingly, the reader/writer body determines the time-length and sequence of each of the antennas in accordance with the distribution strategy of the averaged distribution configured in advance and the length of sustained time for the signal transmission distributed to each port by itself, and acquires the transmitting time and sequence pattern for each of the antennas as shown in FIG. 11; and the antenna of a currently activated RFID tag can be determined according to FIG. 11, and the specific position of the RFID tag can then be determined according to the coverage area of the antenna.

### Example Two

In example two of the present invention, the structural diagram of the RFID reader/writer shown in FIG. 10 is still taken by way of example. In this example, assume a configuration strategy for the signal transmission by polling distribution is set in advance in the reader/writer body and each of the antenna switching units, and assume the length of sustained time for the signal transmission distributed to each port by the reader/writer body is T.

When in practical operation, the antenna switching unit first measures the power level of the signal passing through the port of the reader/writer body connected to the antenna switching unit, and compares the obtained measurement result with a preset transmitting power level threshold; when it reaches the preset transmitting power level threshold, the initial time of reaching signal transmission is determined, and the length of sustained time of the power level of reaching the preset transmitting power level threshold is recorded by the timer, so as to acquire the length of sustained time for the signal transmission distributed to the port by the reader/writer body.

The antenna switching unit, according to the obtained length of sustained time for the signal transmission, equally distributes a time-length of T for the signal transmission to each of the antennas connected to the antenna switching unit in accordance with the configuration strategy of polling distribution; for example, for the two antennas corresponding to port 1, a time-length of T for signal transmission is distributed separately to antenna 1 and antenna 2; if it is for the current transmitting period of port 1, antenna 1 carries out the signal transmission, then antenna 2 carries out the signal transmission for the next transmission period of port 1, and so on.

During the signal transmission, if the reader/writer body selects port 1 to port 4 for carrying out the signal transmission in turn, and the antenna switching unit corresponding to each port selects an antenna in turn and distributes a time-length of T for the signal transmission, then the transmitting time and sequence of each of the antennas is as shown in FIG. 12.

Correspondingly, the reader/writer body determines the time-length and sequence of each of the antennas in accordance with the distribution strategy of polling distribution configured in advance and the length of sustained time for the signal transmission distributed to each port by itself, and acquires the transmitting time and sequence pattern for each of the antennas as shown in FIG. 12; and the antenna of a currently activated RFID tag can be determined according to FIG. 12, and the specific position of the RFID tag then can be determined according to the coverage area of the antenna.

In this example, when it is in a practical implementation, it can be realized by counting the polling process, for example, for the antenna switching unit of port 1, it can be that when the count value is set as 1, antenna 1 is used to carry out the signal transmission during this signal transmission period; when the count value is 2, antenna 2 is used to carry out the signal transmission during this signal transmission period; when the count value is 3, antenna 1 is used to carry out the signal transmission during this signal transmission period; when the count value is 4, antenna 2 is used to carry out the signal transmission during this signal transmission period, and so on. Further, in this example, in order to avoid the counting errors caused by disassembling and assembling of the antenna switching unit or by a counting fault, the reader/writer body can send a resetting signal to the antenna switching unit periodically, and when the antenna switching unit receives the resetting signal, it starts with the initial antenna in the polling sequence, and during each signal transmission period, it separately controls an antenna to perform the signal transmission in accordance with the polling sequence according to the length of sustained time for the signal transmission. For example, for port 1, counting starts with 1, and antenna 1 is used to carry out the signal transmission during this signal transmission period.

In each of the abovementioned embodiments, when information reciprocal is needed between the antenna switching unit and the reader/writer body, a corresponding data line interface can be set up between the two; otherwise, it is enough to connect them merely by the electric cable for connecting the antennas.

The technical solution provided by the present invention can support relatively more antennas without reducing the transmitting power of each of the antennas; at the same time, there is no need to change the internal circuits in the reader/writer body in the preferred embodiments of the present invention, the length of sustained time for the signal transmission distributed to each port by the reader/writer body is measured automatically by the antenna switching unit, and each of the antennas connected thereto is controlled to carry out the signal transmission according to the measured length of sustained time for the signal transmission. In addition, since the reader/writer body and the antenna switching unit can simultaneously monitor the transmission status of each of the antennas during the signal transmission period, the reader/writer body can therefore determine the antenna of a currently activated RFID tag precisely, and determine the position of the RFID tag according to the coverage area of the antenna, so as to realize high precision tracking.

The above description covers only the preferred embodiments of the present invention, and it is not to be used to limit the scope of the present invention. Within the spirit and principle of the present invention, any modifications, equivalent substitutions, improvements and so on are to be included within the scope of protection for the present invention.

1-16. (canceled)

17. A radio frequency identification (RFID) reader/writer, comprising:
a reader/writer body including ports, the reader/writer body configured to distribute to the ports a length of sustained time for transmitting a signal;
antennas;
an antenna switching unit, one end of the antenna switching unit being connected to one port of the reader/writer body, and the other end being connected to two antennas;
wherein the antenna switching unit is configured
to acquire the length of sustained time for the signal transmission distributed to the ports by the reader/writer body,
to perform a configuration of a time-length for a signal transmission and sequence thereof of the two antennas according to the length of sustained time for the signal transmission,
to obtain a configuration result for the signal transmission, and
to perform a switching control on the signal transmission of the two antennas according to a configuration result of the signal transmission.

18. The RFID reader/writer as claimed in claim 17, the antenna switching unit comprising:
a transmission time-length control module for
acquiring the length of sustained time for the signal transmission distributed to the port by the reader/writer body,
configuring, according to the length of sustained time for the signal transmission, the time-length for the signal transmission and sequence thereof of the two antennas in accordance with a preset configuration strategy,
transmitting, according to a configuration result, a control signal to a switching module during the signal transmission; and
a switching module for performing a switching operation on the signal transmission by the two antennas according to the control signal from the transmission time-length control module.

19. The RFID reader/writer as claimed in claim 18, the transmission time-length control module comprising:
a signal transmission time-length acquisition module for acquiring the length of sustained time for the signal transmission distributed to the port by the reader/writer body;
an antenna transmission time-length configuration module for performing, according to the length of sustained time for the signal transmission acquired by the acquisition module, the configuration of the time-length for the signal transmission and sequence thereof of the two antennas in accordance with the preset configuration strategy; and
a control module for transmitting a control signal to the switching module during the signal transmission according to the signal transmission configuration result of the antenna transmission time-length configuration module.

20. The RFID reader/writer as claimed in claim 19, the signal transmission time-length acquisition module comprising:
a signal transmission start/stop time measurement module for
measuring a power level of the signal passing through the port,
for comparing the measurement result with a preset transmission power level threshold, and
for determining the signal transmission's start time and stop time; and
a signal transmission time-length measurement module for recording the sustained time from the start time to the stop time of the signal transmission, so as to acquire the length of sustained time for the signal transmission distributed to the port by the reader/writer body.

21. The RFID reader/writer as claimed in claim 19, the antenna transmission time-length configuration module comprising:
a configuration strategy setting module for setting the configuration strategy of the two antennas; and
a transmission time-length distribution module for configuring the time-length for the signal transmission and sequence thereof of the two antennas in accordance with the configuration strategy set in the configuration strategy setting module according to the length of sustained time for the signal transmission acquired by the signal transmission time-length acquisition module.

22. The RFID reader/writer as claimed in claim 18, the switching module comprising:
a first transmitting/receiving switching module including
a first transmitting/receiving interface,
a first transmitting interface, and
a first receiving interface;
a first transmitting channel formed between the first transmitting/receiving interface and the first transmitting interface;
a first receiving channel formed between the first transmitting/receiving interface and the first receiving interface; and
a second transmitting/receiving switching module including
a second transmitting/receiving interface,
a second transmitting interface, and
a second receiving interface;
a second transmitting channel formed between the second transmitting/receiving interface and the second transmitting interface;
a second receiving channel formed between the second transmitting/receiving interface and the second receiving interface;
an antenna switching module including
a signal receiving interface, and
signal transmitting interfaces of a same number as a number of antennas; and
a coupler including
a coupler signal transmitting interface, and
coupler signal receiving interfaces of a same number as a number of antennas, wherein
the first transmitting/receiving interface is connected to a port of the reader/writer body,
the first transmitting/receiving switching module is used for switching the first transmitting channel and the first receiving channel according to the control signal from the transmission time-length control module,
a number of the second transmitting/receiving switching modules corresponds to a number of antennas,
the second transmitting/receiving interface is connected to the antennas,
the second transmitting/receiving switching module is used for switching the second transmitting channel and the second receiving channel according to the control signal from said transmission time-length control module,
the signal receiving interface is connected to the first transmitting interface of the first transmitting/receiving switching module,
the signal transmitting interfaces are connected to the second receiving interface of the second transmitting/receiving switching module,
the antenna switching module is used for switching channels between the signal receiving interface and the signal transmitting interfaces according to the control signal from the transmission time-length control module,
the coupler signal transmitting interface is connected to the first receiving interface of the first transmitting/receiving switching module,
each of the coupler signal receiving interfaces is connected to the second transmitting interface of one of the second transmitting/receiving switching modules, and
the coupler is used for coupling the signal from the second transmitting/receiving switching module so as to output a signal obtained from one channel to the first transmitting/receiving switching module.

23. The RFID reader/writer as claimed in claim 18, wherein the reader/writer body further determines the antenna corresponding to an activated RFID tag according to the configuration result for the signal transmission, and determines the position of the RFID tag according to a coverage area of the antenna.

24. The RFID reader/writer as claimed in claim 23, the reader/writer body comprising:
an antenna transmission time-length determining module for determining the time-length for the signal transmission and sequence thereof of the two antennas corresponding to each port in accordance with the preset configuration strategy according to the length of sustained time for the signal transmission distributed to each port by the reader/writer body, so as to acquire the configuration result for signal transmission of the two antennas; and
an RFID tag position determining module for determining the antenna corresponding to the activated RFID tag according to the configuration result for signal transmission, and for determining the position of the RFID tag according to the coverage area of the antenna.

25. An implementation method for antenna switching of a radio frequency identification RFID reader/writer, wherein an antenna switching unit is disposed between a reader/writer body and the antennas, one end of the antenna switching unit being connected to one port of the reader/writer body, and the other end being connected to two antennas, the method comprising:
acquiring, by the antenna switching unit, a length of sustained time for a signal transmission distributed to the port connected to the antenna switching unit by the reader/writer body;
performing a configuration of a time-length for the signal transmission and sequence thereof of each of the antennas connected to the antenna switching unit according to the length of sustained time for the signal transmission, so as to acquire the configuration result for the signal transmission; and
performing a switching control on the signal transmission by each of the antennas connected to the antenna switching unit according to a configuration result for the signal transmission.

26. The method as claimed in claim 25, wherein the step for acquiring with the antenna switching unit the length of sustained time for the signal transmission distributed to the port connected to the antenna switching unit by the reader/writer body comprises:
measuring a signal's power level passing through the port by the antenna switching unit;
comparing the obtained measurement result with a preset transmission power level threshold so as to determine a start time and a stop time of the signal transmission; and
recording the sustained time from the start time to the stop time of the signal transmission, so as to acquire the length of sustained time for the signal transmission distributed to the port by the reader/writer body.

27. The method as claimed in claim 25, wherein the step for performing the configuration of the time-length for the signal transmission and sequence thereof of each of the antennas connected to the antenna switching unit according to the length of sustained time for the signal transmission so as to acquire the configuration result for the signal transmission comprises:
setting a signal transmission configuration strategy for each of the antennas connected to the antenna switching unit; and
configuring the time-length for the signal transmission and sequence thereof of each antenna in accordance with the signal transmission configuration strategy and according to the length of sustained time for the signal transmission, so as to acquire the signal transmission configuration result.

28. The method as claimed in claim 27, wherein the signal transmission configuration strategy is:
the length of sustained time for the signal transmission is equally distributed to each of the antennas connected to the antenna switching unit, or
the length of sustained time for the signal transmission is distributed to each of the antennas connected to the antenna switching unit in accordance with a preset weighting coefficient.

29. The method as claimed in claim 28, wherein the step for performing the switching control on the signal transmission by the two antennas connected to the antenna switching unit according to the configuration result for the signal transmission is:
according to the signal transmission configuration result, and during the signal transmission period, each of the antennas is controlled to perform the signal transmission in accordance with the time-length for the signal transmission and sequence thereof configured for the antenna.

30. The method as claimed in claim 27, wherein the signal transmission configuration strategy is:
the length of sustained time for the signal transmission is distributed in turn to one of the antennas connected to the antenna switching unit.

31. The method as claimed in claim 30, wherein the step for performing the switching control on the signal transmission by the two antennas connected to the antenna switching unit according to the configuration result for the signal transmission is:
according to the signal transmission configuration result, and during each signal transmission period, one antenna is separately controlled to perform the signal transmission in accordance with a polling sequence according to the length of sustained time for the signal transmission.

32. The method as claimed in claim 31, further comprising:
sending periodically a resetting signal by the reader/writer body to the antenna switching;
receiving the resetting signal by the antenna switching unit; and
executing, beginning with an initial antenna in the polling sequence, in each signal transmission period, the step of one antenna being separately controlled to perform the signal transmission in accordance with the polling sequence according to the length of sustained time for the signal transmission.

33. The method as claimed in claim 25, further comprising:
determining by the reader/writer body the antenna corresponding to the activated RFID tag according to the signal transmission configuration result; and
determines the position of the RFID tag according to the coverage area of the antenna.

34. The method as claimed in claim 33, wherein before the reader/writer body determines the antenna corresponding to the activated RFID tag according to the signal transmission configuration result, the method further comprises:
determining by the reader/writer body the time-length for the signal transmission and sequence thereof of each of the antennas corresponding to the port in accordance with the preset configuration strategy according to the length of sustained time for the signal transmission distributed to each port by the reader/writer body, so as to acquire the signal transmission configuration result of each of the antennas.
